(19) United States
(12) Patent Application Publication
(10) Pub. No.: US 2007/0294987 A1
(43) Pub. Date: Dec. 27, 2007

(54) NATURAL GAS FILTER FOR PARTICULATE AND LIQUID IMPURITIES

(76) Inventors: Gary Hunsinger, Rochester, NY (US); Matthew Geier, Webster, NY (US)

Correspondence Address: HOFFMAN WARNICK & D'ALESSANDRO, LLC, 75 STATE STREET, 14TH FLOOR, ALBANY, NY, 12207, US

(21) Appl. No.: 11/834,925

(22) Filed: Aug. 7, 2007

Related U.S. Application Data
(63) Continuation-in-part of application No. 11/299,261, filed on Dec. 7, 2005.

(51) Int. Cl. B01D 46/24

(52) U.S. Cl. 55/486; 55/482

(57) ABSTRACT

A filtration apparatus for separating particulate and liquid impurities, such as dust, liquid or oil, from a natural gas. The filtration apparatus has a horizontally oriented filter enclosure with a plurality of filter elements which are not in parallel with the long axis of the enclosure, thus enabling filtered particles to fall out of the filter elements into a collection sump for later removal. A dividing plate, upon which the filter elements are mounted, is angled slightly out of level for the purpose of guiding the filtered particulate and liquid impurities to a collection sump. The gas flowing into the enclosure undergoes a rapid expansion, which serves to remove larger particles and liquids entrained in the gas. The gas is further “pre-filtered” by forcing it through a tortuous path of abrupt changes in direction prior to encountering the filter elements.

This application is a continuation-in-part application of U.S. Ser. No. 11/299,261, filed Dec. 7, 2005, currently pending.

### FIELD OF THE DISCLOSURE

This disclosure relates to filters and filter/separators used, for example, in the removal of liquids and/or solids from a stream of natural gas.

### BACKGROUND OF THE DISCLOSURE

When it is originally mined, natural gas exists in a “dirty” state with entrained liquids, particulates and other impurities, which must be removed before shipping the gas to distribution hubs via a pipeline network. Filter apparatus designs are plentiful in this area, however, none of the designs for the filtration of particulates or liquids effectively addresses the issues of maximizing filter effectiveness and reducing filter maintenance while, at the same time, maintaining a configuration that allows for easy access and minimal visual impact.

For example, many filtration systems disclosed in prior art are vertical in nature. This is to say that the long axis of the apparatus is substantially vertical, with the filter inlet located at the top and the outlet located at the bottom or vice-versa. As is able to be seen in schematics or photographs of such a design, a vertically mounted filtration apparatus has an unusually large physical profile. With such designs, an apparatus must be either at least partially underground or be accompanied with a ladder for a worker to reach the full height. However, a vertically oriented filter underground would be substantially inaccessible for maintenance and, if placed above ground, the replacement of some filter elements installed within a vertically oriented enclosure may be a significant distance off the ground, increasing the possibility of injury to the workers. Consequently, a filtration apparatus with a horizontal orientation is desired in the art.

Additionally, most filtration systems contain filter elements oriented in a substantially horizontal direction although, in many of these designs, this cannot be helped as the horizontal arrangement of the filter elements is dictated by the orientation of the enclosure containing these elements. Horizontal elements, however, are generally deficient for a number of reasons. First, particles that are filtered out will settle in the filter material causing a gradual buildup of particulates. Such buildup leads to potential clogging, increased need for filter replacement and potential filter failure. Second, horizontally aligned filter elements are difficult to access and repair. Typically, these filters must be removed out of the side of the filtration apparatus enclosure, or else the enclosure itself must be completely disassembled. Both issues can present significant time requirements for filter replacement and increase down-time of the filter's operability. Further, effectively sealing the ends of horizontally installed filter elements is difficult and oftentimes impossible.

Also, filter life may be enhanced through the use of “pre-filtering” or removal of larger particulates prior to the gas interacting with the filter. Many designs do not contemplate the concept that the life of a filter element will be lengthened, and need for maintenance thereby reduced, when the level of particulates is reduced in the gas prior to the filter elements. Thus, a filtration apparatus with a pre-filtering capability is desired in the art.

While some designs in the prior art contemplate some aspects of the present disclosure, none recognize the need for these aspects in a single design. For example, U.S. Pat. No. 4,298,474 to Sillers discloses a “multiple filter vessel”, which comprises a plurality of filters in a generally horizontal enclosure. However, the filters are in a horizontal orientation and it is impossible to repair or replace these filters without disassembling the entire enclosure. Therefore, maintenance of the filter elements in this design may be difficult and inefficient.

U.S. Pat. No. 3,375,058 to Peterson et al. discloses an “apparatus and method for separating suspended substances from gas currents”. This disclosure involves the expansion and abrupt change in gas flow for the removal of particles through the use of slits and nozzles. However, these units are horizontally mounted leading to the potential buildup of particulates and clogging of the elements. Furthermore, this disclosure does not disclose the use of a mesh filter or some other conventional filter element commonly seen in other related art.

U.S. Pat. No. 4,666,473 to Gerdau discloses a “separator for gases and liquids”. This disclosure discloses a filter with a vertical filter element and also utilizes an angled flow path to allow for coarse particulate removal. However, this design does not allow for the use of multiple filter elements, which would spread out filter wear and thereby reduce maintenance requirements. Also, this design is generally vertical in nature and does not solve the problems of tall profile or pipe flow restriction inherent in vertical filtration apparatus design.

U.S. Pat. No. 5,919,284 to Petty et al. discloses a “gas filter coalescer and multistage vessel”. This disclosure discloses a horizontally oriented enclosure, however, the filter elements are also of a horizontal orientation which may lead to particulate buildup within the filter element resulting in shorter filter element life and increased maintenance requirements. Furthermore, access to the filter elements is limited and replacement may be difficult. This may result in increased maintenance time and subsequent down time of the filtration apparatus as a whole.

### SUMMARY

The present disclosure is a filtration apparatus for natural gas with the ability to remove particulates, entrained liquid, or a combination of the two. The disclosure comprises a horizontally oriented filter enclosure, preferably of cylindrical shape, with a closure head on each end. Connected at each closure head is either an inlet or outlet through which the gas enters or exits the enclosure. Within the enclosure is a dividing plate that functions primarily for preventing gas from by-passing the filter elements as well as providing a structural foundation for mounting a plurality of filter elements. For every individual filter element installed in the enclosure, an access point is provided for easy repair, removal and replacement of used filter elements without the total disassembly of the filtration apparatus. In addition, this disclosure includes a number of aspects which make it much more effective than other designs.

First, the enclosure is in a horizontal arrangement, thereby avoiding many of the deficiencies intrinsic to a vertically mounted filtration apparatus. The profile is much lower and non-obtrusive than a vertically mounted apparatus and, in fact, the filtration apparatus can be installed partially or completely underground and still be easily accessible. Furthermore, a horizontal arrangement runs in the same direction as the piping thereby simplifying installation and streamlining pipeline flow path

Second, the horizontal arrangement of the enclosure allows for a plurality of filter elements to be vertically installed, side by side, within the enclosure. This design allows unfiltered gas to enter vertically upward into the filter element chamber, wherein the particles which are filtered out are much less likely to stay in the filter element chamber, but instead will fall out of the filter into a collection sump where it can be periodically removed. Because of this design, filter elements last longer, perform more efficiently and are less likely to fail than filter elements that are horizontally mounted in the enclosure.

A third aspect of this disclosure is its ability to channel flow of filtered particulates and liquids to collection sumps and disposal. In the preferred embodiment, where the filter elements are upright, the dividing plate is slightly (1-3°) off level both along the long and short axis of the enclosure. This “tilting” of the dividing plate allows for the channeling of any removed liquid to a collection sump where it can be drained.

Another aspect to the present disclosure is the location of the dividing plate and the role it serves in pre-filtering a gas. Experimental use has shown that the dividing plate baffles, which fasten the dividing plate to the enclosure wall, interfere with the gas flow as it enters the enclosure from the inlet nozzle and force the gas to be suddenly redirected as it proceeds through the enclosure. These abrupt redirections, which create a tortuous flow path for the gas resulting in more turbulent gas flow, result in a large amount of particulate removal before the gas encounters the filter elements. This removal of particulates through the turbulent redirection of gas significantly enhances filter element life and reduces the need for filter element maintenance.

The prefiltering characteristics of this disclosure are also enabled by the enclosure design. In the most preferred embodiment, the cross sectional area of the flow path dramatically increases as the gas leaves the inlet nozzle and enters the enclosure itself. This large change in cross sectional area results in a similar rapid increase in gas volume. This sudden expansion aids in the removal of particulate and liquid matter from the gas prior to it reaching the filter elements. This attribute also significantly enhances filter element life and reduces the need for filter element maintenance.

In another aspect, the outlet includes a closed-ended plenum to which at least one second filter element may be attached at openings in the plenum, thus providing an additional filtering stage.

### BRIEF DESCRIPTION OF THE DRAWINGS

The above-mentioned and other features and aspects of this disclosure, and the manner of attaining them, will become apparent and be better understood by reference to the following description of one embodiment of the disclosure in conjunction with the accompanying drawings, wherein:

FIG. 1 is a side view of the filtration apparatus as disclosed in the present disclosure.

FIG. 2 is a cross sectional view of the filtration apparatus as disclosed in the present disclosure.

FIG. 3 is a close view of the cylindrical view of the filter element used in the most preferred embodiment of the present disclosure.

FIG. 4 is a close view of the filter element fastener.

FIG. 5 is a close view of the filter element and filter element fastener as applied in the present disclosure.

FIG. 6 is a side view of another embodiment of the filtration apparatus including other filter element(s) attached to a closed-ended plenum of the outlet.

Corresponding reference characters indicate corresponding parts throughout the several views. The examples set out herein illustrate one embodiment of the disclosure but should not be construed as limiting the scope of the disclosure in any manner.

### DETAILED DESCRIPTION

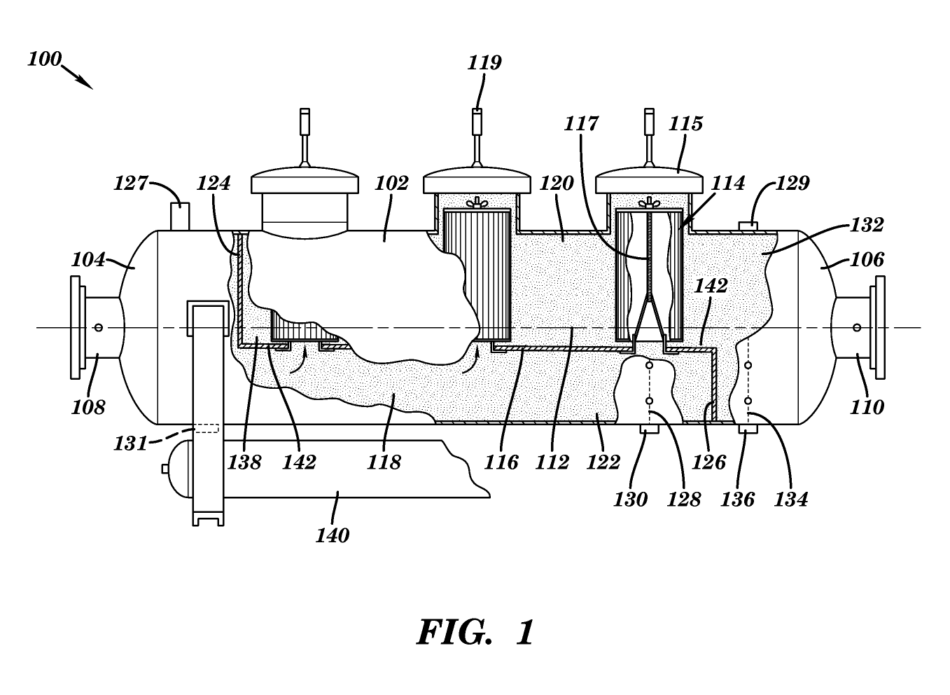

The current disclosure discloses a filtration apparatus for all types of natural gases and specifically, in the most preferred embodiment, coal bed methane (CBM). As may be viewed in FIG. 1, a filtration apparatus 100 includes a substantially horizontally oriented filter enclosure 102, with a closure head 104, 106 on each end. Attached to each closure head is an opening for the flow of CBM in or out of filtration apparatus 100. An inlet 108, is attached to inlet closure head 104 and, similarly, an outlet 110, is attached to outlet closure head 106. Inlet 108 or outlet 110 may be attached at any location on its respective closure head 104, 106 and may even be attached directly on the body of enclosure 102 itself. In one embodiment, inlet 108 and outlet 110 are attached substantially to the center of their respective closure heads 104, 110 as this allows a relatively continuous alignment along a long axis 112 of filtration apparatus 100. Enclosure 102 and associated closure heads 104, 106 may be a number of shapes including square or rectangular prism, but the most preferred shape is cylindrical.

Within enclosure 102 are at least one, and in most cases, a plurality of filter elements 114 arranged in parallel to allow simultaneous filtration through all the elements. In one embodiment, filter elements 114 are cylindrical in shape and are mounted, at one end, to a dividing plate 116 which separates enclosure 102 into an inlet side 118 and an outlet side 120. As one can see from FIG. 1, dividing plate 116 prevents the flow of CBM gas from inlet 108 to outlet 110 without traveling first through one of any number of filter elements 114.

Because of the substantially horizontal orientation of enclosure 102, filter elements 114 may be aligned in an orientation out of parallel with long axis 112 of enclosure 102 in a side-by-side arrangement. As shown in FIG. 1, one orientation of filter elements 114 is substantially perpendicular to long axis 112, although this will depend upon the shape of the filter element. This alignment is beneficial over a horizontal alignment commonly found in prior art because it allows particulates that are filtered out to fall, aided by gravity, out of a filter element 114 and into a collection sump 122 at the bottom of enclosure 102. Such a design dramatically increases filter efficiency, reduces the risk of filter failure and lowers the time in which the apparatus is inoperative due to maintenance. Also, since the gas to be filtered must travel up into filter elements 114 through openings in dividing plate 116 from below, this design is specifically useful for light gases as opposed to relatively heavy liquids.

Filter elements 114 may be comprised of a number of materials and serve a number of functions. Such compositions include, but are not limited to, polyester, fiberglass, or some combination thereof. In general, and as shown in FIG. 3, a filter element 114 may be cylindrical in shape, but it does not have to be of this configuration. The actual filtering material 300 is placed in a zig-zag pattern, thereby maximizing the surface area for more effective filtration. Both an inlet side 302 and an outlet side 304 of filter element 114 are covered in a porous metal casing 306 for both structural support and offering a location for liquid drop formation if the filter element is to serve a coalescing function. In FIG. 3, a porous metal casing 306 is designed with a large number of small holes 308. The size of holes 308 can be altered to change the metal casing's porosity. This may be especially important in cases where filter element 114 will serve a coalescing function.

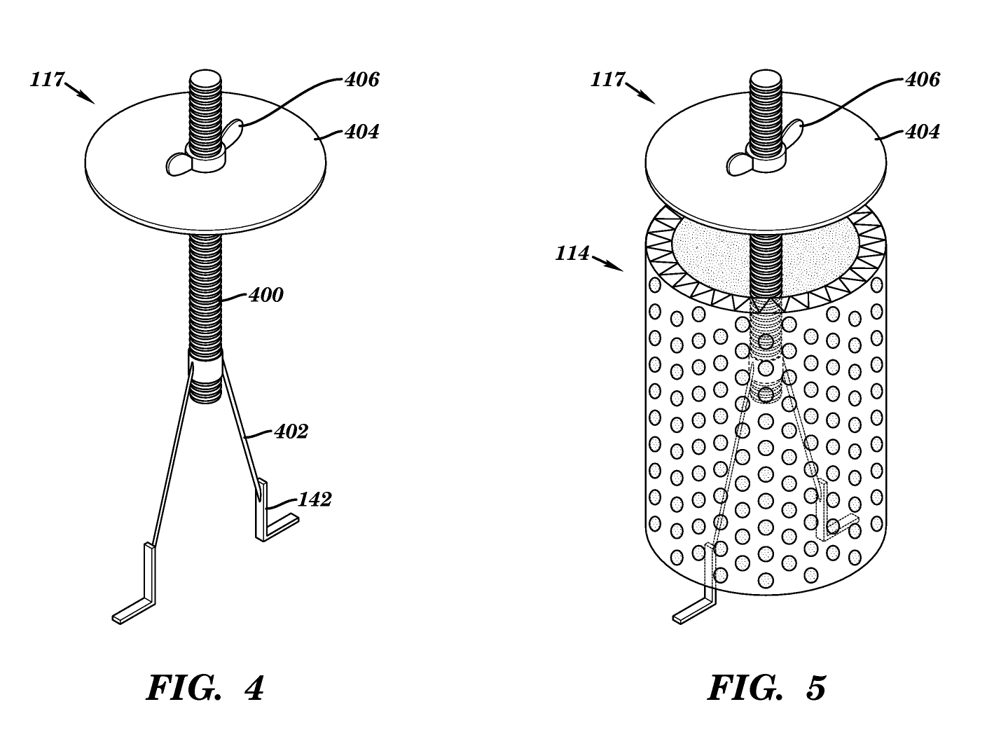

Due to the potentially high flow rate of the CBM gas, filter elements 114 must be held in place by a fastener 117 which is shown in more detail in FIG. 4. In one embodiment, fastener 117 comprises a threaded metal rod 400 which is attached at its bottom to a number of lower connecting rods 402. Connecting rods 402 are attached to a baffle 142, which penetrates dividing plate 116, as seen on FIG. 1 and also provides a physical seal between dividing plate 116 and filter element 114. To prevent the leaking of CBM gas out the upper end of filter element 114, fastener 117 also comprises a disc shaped cap 404, placed around threaded rod 400 and will seal the top of filter element 114. To secure filter element 114 and to minimize leak past cap 404, a nut 406 is used to tighten cap 404. Any fastening nut may be used, however, for the ease of maintenance, a butterfly nut is most effective. When a filter element is installed, it will be fastened as seen in FIG. 5. Fastener 117 may be welded to dividing plate 116, or may be bolted for ease of assembly and/or replacement.

For the ease of maintenance, each filter element 114 may be accessed through an access point 115 in the form, for example, a quick opening closure. Access points 115 may be screw-on, hinged or firmly attached by other means. The ability to remove and replace filter elements 114 out of the top of the enclosure 102 via access points 115 should be apparent. Due to the generally horizontal arrangement of filtration apparatus 100, it is possible that the filter apparatus could be almost entirely underground, wherein the only aspect above ground are access points 115 for the periodic replacement or repair of filter elements 114. Because of the contemplated arrangement where the bulk of filtration apparatus 100 is inaccessible (i.e. underground), access points 115 are each accompanied by a pressure relief connection 119 to prevent an overpressure condition in enclosure 102. In a situation where the filtration apparatus 100 is accessible (i.e., not underground), pressure relief connections 127, 129 are supplied on inlet side 118 and outlet side 120 of enclosure 102. While it is not normally expected that filtration apparatus 100 will operate at high pressure, higher operating pressures are capable of being supported by the disclosure. In addition, the pressure relief connections 119, 127, 129 protect enclosure 102 from structural damage in the case of an ignition of the CBM gas, which may result in an extremely high pressure pulse due to the rapid expansion of the ignited gas (known as “flash” pressure).

In one embodiment, as shown in FIG. 1, dividing plate 116, upon which filter elements 114 are attached, is substantially parallel to long axis 112 of the enclosure 102. Unlike disclosures disclosed in prior art, dividing plate 116 does not extend straight across the enclosure, but instead is mounted in enclosure 102 through the use of two baffle plates 124, 126. Although baffle plates 124, 126 serve the purpose of structural stability of dividing plate 116, inlet side baffle 124, also serves a very useful purpose in the filtration process. As is shown in FIG. 1, gas that enters into enclosure 102 via inlet 108 will impact inlet side baffle 124 and be abruptly shifted downward and into the inlet side of dividing plate 116. This tortuous flow path that the gas must travel causes a large amount of particulate and liquid separation before the gas encounters filter elements 114. Experimental use has shown that this method of particulate/liquid removal creates vastly improved filtering performance as well as increased preservation of filter elements 114, resulting in less filter element failure and reduced maintenance requirements. Particulate and liquid removal is also enhanced through the large volumetric change the CBM gas encounters when it leaves inlet 108 and enters the much larger area comprising the inside of inlet closure head 104 and the area of enclosure 102 before baffle plate 124.

Particulates and liquids that are removed through both expansion of the CBM gas and the tortuous flow path that the gas must undergo fall to the bottom of enclosure 102, which also serves as an inlet side collection sump 122. As can be seen in FIG. 1 and as previously mentioned, inlet side collection sump 122 also collects particulates and liquids that are filtered out in filter elements 114 and fall, gravity aided, out of the filter element. Inlet side collection sump 122 level can be measured by a gauge glass 128, which is located on the side of enclosure 122. When inlet side collection sump 122 is full, the filtrate may be removed via an inlet side collection sump drain port 130 installed at the bottom of inlet side collection sump 122. Due to the length of inlet side collection sump 122, a second drain port 131 may be necessary. Also, for ease of use, drain port 130 is installed directly below gauge glass 128, however, the drain port can theoretically be installed anywhere within inlet side collection sump 122.

On the occurrence that some particulate, liquid or mixture thereof is removed, but is extracted on the outlet side of filter elements 114, an outlet side collection sump 132 may be necessary as well. Much like its counterpart on the inlet side of dividing plate 116, outlet side collection sump 132 is also accompanied by a gauge glass 134 and a drain port 136. In one embodiment, outlet side collection sump 132 is at the bottom of enclosure 102 and bracketed by outlet side baffle 126 and outlet side closure head 106.

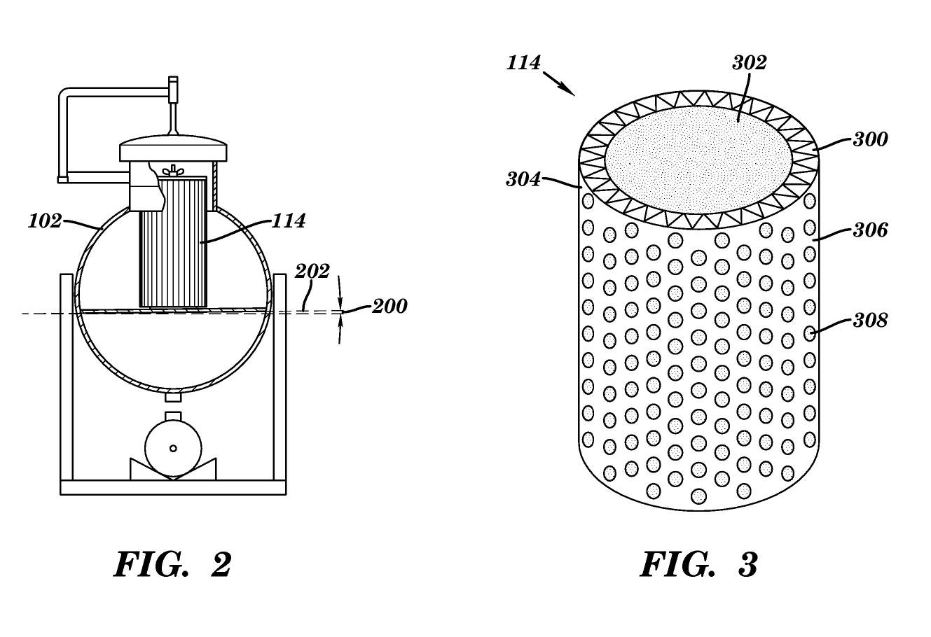

As a buildup of particulate/liquid filtrate on the outlet side of filter elements 114 could significantly impede filter element performance, the filtrate must be channeled to outlet side collection sump 132. Therefore, in one embodiment, dividing plate 116 is at a small angle 138 (e.g., 1°-3°) from parallel with both long axis 112 of enclosure 102 and a similarly small angle 200 with a short axis 202 of enclosure 102, as shown in FIG. 2. These small angles enable filter elements 114 to remain substantially perpendicular to long axis 112 of enclosure 102, thereby preventing particulate buildup in filter elements 114, while guiding filtered particles and liquids on the outlet side to outlet side collection sump 132.

To protect the collection sumps 122, 132 from overflowing, a holding tank 140 may be installed under drain ports 130, 131 and 136 thus enabling collection sumps 122, 132 to be periodically drained while, at the same time, preventing the particulate/liquid filtrate from being released into the environment.

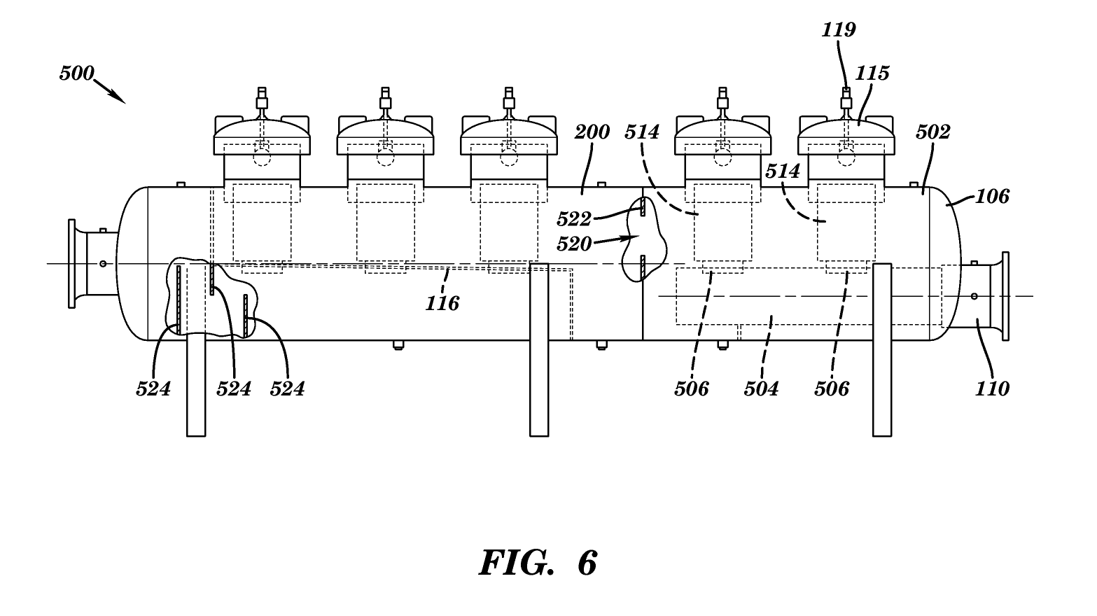

Referring to FIG. 6, a side view of another embodiment of a filtration apparatus 500 is illustrated. Filtration apparatus 500 includes a horizontally oriented enclosure 102 that has been extended compared to that of FIGS. 1-5. Enclosure 102 may be formed in an elongated manner as one unit or closure head 106 may be removed and an additional length of enclosure 502 added. A closed-end plenum 504 is added to outlet 110 and at least one filter element 514 is attached to opening(s) 506 in closed-ended plenum 504. Closed-ended plenum 514 may be made of any non-corrosive material, for example, stainless steel or other non-corrosive material. Outlet 110 may be lowered in position on closure head 106 to allow for filter element(s) 514 to be positioned on closed-ended plenum 504. Each filter element 514 may be a pleated type or canister type, as described above, and may be attached via a fastener 117 (FIGS. 4-5). Each filter element 514 may include its own access point 115 and/or pressure relief connection 119. A wall 520 including an opening 522 is positioned substantially vertically within enclosure 102 to separate the extension of enclosure 102 from the non-extend portion, i.e., filter elements 514 on closed-ended plenum 504. Opening 522 in wall 520 is positioned at an upper region of wall 520 and a bottom region of wall 520 is solid to prevent fluid from flowing from outlet side collection sump 122 to plenum 504.

FIG. 6 also shows a plurality of plates 524 positioned to further disrupt a flow path of gas as it flows through inlet side collection sump 118. That is, plates 524 add to the pre-filtering by forcing the gas through a more tortuous path of abrupt changes in direction prior to encountering filter elements 114. In one embodiment, plates 524 may be perforated or include slots therein allow restricted gas flow therethrough. Plates 524 may also be employed in the embodiments of FIG. 1. Filtration apparatus 500 is otherwise substantially identical to filtration apparatus 100 (FIG. 1). Filtration apparatus 500 adds another stage of filtering, i.e., filter elements 514, for particulates such as hydrogen sulfide. Accordingly, filtration apparatus 500 provides filtering via inertial impaction (inlet side collection sump 118), gravitational settling, direct impingement, coalescing and active particulate filtering.

While the disclosure has been described with reference to a particular embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the scope of the disclosure.

Therefore, it is intended that the disclosure not be limited to the particular embodiments disclosed as the best mode contemplated for carrying out this disclosure, but that the disclosure will include all embodiments falling within the scope and spirit of the appended claims.

What is claimed is:

1. A filtration apparatus for natural gas comprising:
a horizontally oriented filter enclosure with an inlet and an outlet, wherein the outlet includes a closed-ended plenum extending into the horizontally oriented filter enclosure;
a dividing plate disposed within the horizontally oriented filter enclosure between the inlet and the outlet;
a first plurality of filter elements, each of the first plurality of filter elements attached at an opening in the dividing plate, the dividing plate and the first plurality of filter elements separating the horizontally oriented filter enclosure into an inlet side collection sump and an outlet side collection sump;
a second plurality of filter elements, each of the second plurality of filter elements attached to an opening in the closed-ended plenum; and an access point for accessing each of the filter elements.

2. The filtration apparatus of claim 1, wherein each of the filter elements are in a non-parallel alignment with a long axis of the horizontally oriented filter enclosure.

3. The filtration apparatus of claim 1, wherein each of the filter elements are substantially vertical.

4. The filtration apparatus of claim 1, wherein the dividing plate to which the first plurality of filter elements are attached is substantially parallel with a long axis and a short axis of the horizontally oriented filter enclosure.

5. The filtration apparatus of claim 1, wherein the dividing plate is disposed at an angle relative to a long axis of the horizontally oriented filter enclosure and guides a flow of liquid and particulate filtrate from an outlet side of the filter elements to the outlet side collection sump.

6. The filtration apparatus of claim 5, wherein the dividing plate is disposed at an angle relative to a short axis of the horizontally oriented filter enclosure.

7. The filtration apparatus of claim 5, further comprising a drain connecting port attached to a bottom of each collection sump for periodic collection of accumulated filtrate.

8. The filtration apparatus of claim 1, wherein the natural gas leaving the inlet enters a zone of relatively large volume enabling rapid expansion of the natural gas.

9. The filtration apparatus of claim 1, wherein the natural gas entering the horizontally oriented filter enclosure proceeds through a tortuous flow path before reaching the filter elements.

10. The filtration apparatus of claim 1, further comprising a collection tank placed beneath the horizontally oriented filter enclosure for collection of filtered liquid and particulate.

11. The filtration apparatus of claim 1, wherein the at least one first filter element performs at least one of: filtering solid particulates from the natural gas, and coalescing removal of entrained liquids.

12. The filtration apparatus of claim 1, wherein each of the first plurality of filter elements are individually fastened to the dividing plate via a fastener, and each of the second plurality of filter elements are individually fastened to the closed-ended plenum via a fastener.

13. The filtration apparatus of claim 1, further comprising a wall positioned between the second plurality of filter elements on the closed-ended plenum and the outlet side collection sump, the wall including an opening in an upper region thereof.

14. The filtration apparatus of claim 1, further comprising a plurality of plates positioned within the inlet side collection sump to disrupt flow of the natural gas.

15. The filtration apparatus of claim 1, wherein the second plurality of filter elements filter hydrogen sulfide.

16. A filtration apparatus for natural gas comprising:
a horizontally oriented filter enclosure with an inlet and an outlet, wherein the outlet includes a closed-ended plenum extending into the horizontally oriented filter enclosure;
a dividing plate disposed within the horizontally oriented filter enclosure between the inlet and the outlet, the dividing plate is disposed at an angle relative to a long axis of the horizontally oriented filter enclosure;
at least one first filter element attached at an opening in the dividing plate, the dividing plate and the at least one first filter element separating the horizontally oriented filter enclosure into an inlet side collection sump and an outlet side collection sump;
at least one second filter element attached to an opening in the closed-ended plenum; and
an access point for accessing each of the filter elements.

17. The filtration apparatus of claim 16, wherein each of the filter elements are substantially vertical.

18. The filtration apparatus of claim 16, wherein the dividing plate is disposed at an angle relative to a short axis of the horizontally oriented filter enclosure.

19. The filtration apparatus of claim 16, further comprising a drain connecting port attached to a bottom of each collection sump for periodic collection of accumulated filtrate.

20. The filtration apparatus of claim 16, wherein the natural gas leaving the inlet enters a zone of relatively large volume enabling rapid expansion of the natural gas.

21. The filtration apparatus of claim 16, wherein the at least one first filter element performs at least one of: filtering solid particulates from the natural gas, and coalescing removal of entrained liquids.

22. The filtration apparatus of claim 16, wherein the at least one second filter element filters solid particulates.

23. The filtration apparatus of claim 16, wherein each of the at least one first filter elements are individually fastened to the dividing plate via a fastener, and each of the at least one second filter elements are individually fastened to the closed-ended plenum via a fastener.

24. The filtration apparatus of claim 16, further comprising a wall positioned between the second plurality of filter elements on the closed-ended plenum and the outlet side collection sump, the wall including an opening in an upper region thereof.

25. The filtration apparatus of claim 16, further comprising a plurality of plates positioned within the inlet side collection sump to disrupt flow of the natural gas.

26. The filtration apparatus of claim 16, wherein the second plurality of filter elements filter hydrogen sulfide.
